(19) United States
(12) Patent Application Publication
(10) Pub. No.: US 2022/0316328 A1
(43) Pub. Date: Oct. 6, 2022

(54) REAL TIME DULL BIT GRADING MODELING AND PROCESS TECHNIQUE

(71) Applicant: Landmark Graphics Corporation, Houston, TX (US)

(72) Inventors: Aman Srivastava, Dallas, TX (US); Geetha Gopakumar Nair, Katy, TX (US)

(21) Appl. No.: 17/361,964

(22) Filed: Jun. 29, 2021

Related U.S. Application Data
(60) Provisional application No. 63/170,851, filed on Apr. 5, 2021.

(51) Int. Cl. E21B 49/00; E21B 44/00; G01V 5/12

(52) U.S. Cl. CPC E21B 49/003; E21B 44/00; G01V 5/12; E21B 2200/22

(57) ABSTRACT

The disclosure provides a method for evaluating a worn-out condition of a drilling bit in real time, i.e., when the drilling bit is drilling in the borehole. The method disclosed herein incorporates both physics based as well as machine learning based aspects to provide existing and forecasted evaluations. In one example a method of evaluating properties of a drilling bit when in a borehole is disclosed that includes: (1) determining formation properties corresponding to a subterranean formation at a location of the drilling bit in the borehole, (2) calculating an existing bit wear condition of the drilling bit based on the formation properties, (3) providing a forecasted bit wear condition of the drilling bit based on the existing bit wear condition and real time parameters, and (4) evaluating performance of the drilling bit based on the forecasted bit wear condition.

### CROSS-REFERENCE TO RELATED APPLICATION

This application claims the benefit of U.S. Provisional Application Ser. No. 63/170,851 filed by Aman Srivastava, et al. on Apr. 5, 2021, entitled “REAL TIME DULL BIT GRADING MODELING AND PROCESS TECHNIQUE,” commonly assigned with this application and incorporated herein by reference in its entirety.

### BACKGROUND

A drilling bit, such as a Tri-Cone Insert (TCI) bit or polycrystalline diamond compact (PDC) bit, is located at the bottom of a drill string and suffers the impact of the formation while drilling and cutting. The drilling bit gets worn out as the drilling progresses and the worn-out condition is graded after pulling the drilling bit out of the borehole. Unfortunately, the drilling bit can be pulled out of the borehole due to, for example, a poor rate of penetration and then observed that the drilling bit is not worn and could have been used for more drilling. Such trips to the surface due to inaccurate information about the drilling bit can cause severe loss to an operator; especially when drilling at deeper depths.
After pulling a drilling bit out of borehole, the wear pattern of the bit is observed, and a grading is provided to the dulled condition. This grading, known as dull bit grading, is per the standards set by International Association of Drilling Contractors (IADC). The first two numbers of the dull bit grading indicate the level of degradation with 0 being no wear and 8 being completely worn out. The visual observation and grading of the drilling bit are only performed after the bit is pulled out of borehole.

### SUMMARY

In one aspect, the disclosure provide a method of evaluating properties of a drilling bit when in a borehole. In one example the method includes: (1) determining formation properties corresponding to a subterranean formation at a location of the drilling bit in the borehole, (2) calculating an existing bit wear condition of the drilling bit based on the formation properties, (3) providing a forecasted bit wear condition of the drilling bit based on the existing bit wear condition and real time parameters, and (4) evaluating performance of the drilling bit based on the forecasted bit wear condition.

In another aspect, the disclosure provides an apparatus. In one example, the apparatus includes at least one processor and memory, the memory including computer program code. In one example, the memory and the computer program code are configured to, with the at least one processor, cause the apparatus to evaluate properties of a drilling bit in a borehole by performing at least the following: (1) determining formation properties corresponding to a subterranean formation at a location of the drilling bit in the borehole, (2) calculating an existing it wear condition of the drilling bit based on the formation properties, (3) forecasting a forecasted bit wear condition of the drilling bit based on the existing bit wear condition, and (4) evaluating performance of the drilling bit based on the forecasted bit wear condition.

In yet another aspect, the disclosure provides a computer program product having a series of operating instructions stored on a non-transitory computer-readable medium that directs a data processing apparatus when executed thereby to perform operations. In one example the operations include: (1) determining formation properties corresponding to a subterranean formation at a location of the drilling bit in the borehole, (2) calculating an existing bit wear condition of the drilling bit based on the formation properties, (3) providing a forecasted bit wear condition of the drilling bit based on the existing bit wear condition and real time parameters, and (4) evaluating performance of the drilling bit based on the forecasted bit wear condition.

### BRIEF DESCRIPTION

Reference is now made to the following descriptions taken in conjunction with the accompanying drawings, in which:

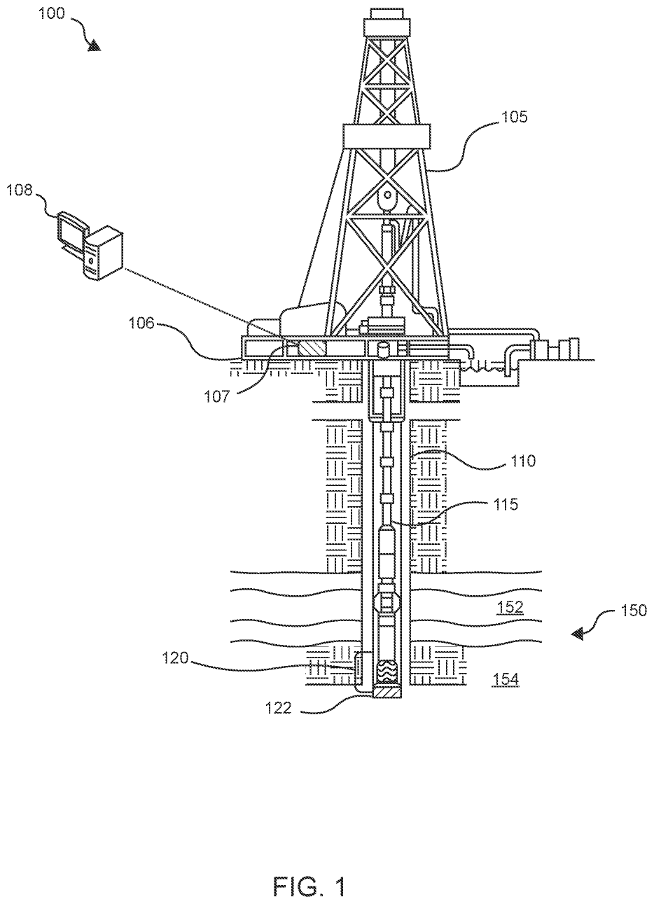

FIG. 1 illustrates a diagram of an example drilling system that can evaluate properties of a drilling bit in a borehole according to the principles of the disclosure;

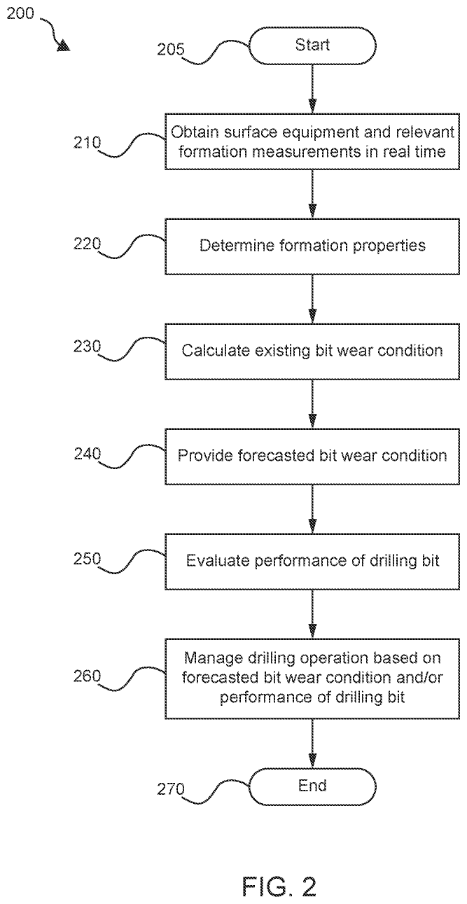

FIG. 2 illustrates a flow diagram of an example of a method of evaluating properties of a drilling bit carried out according to the principles of the disclosure;

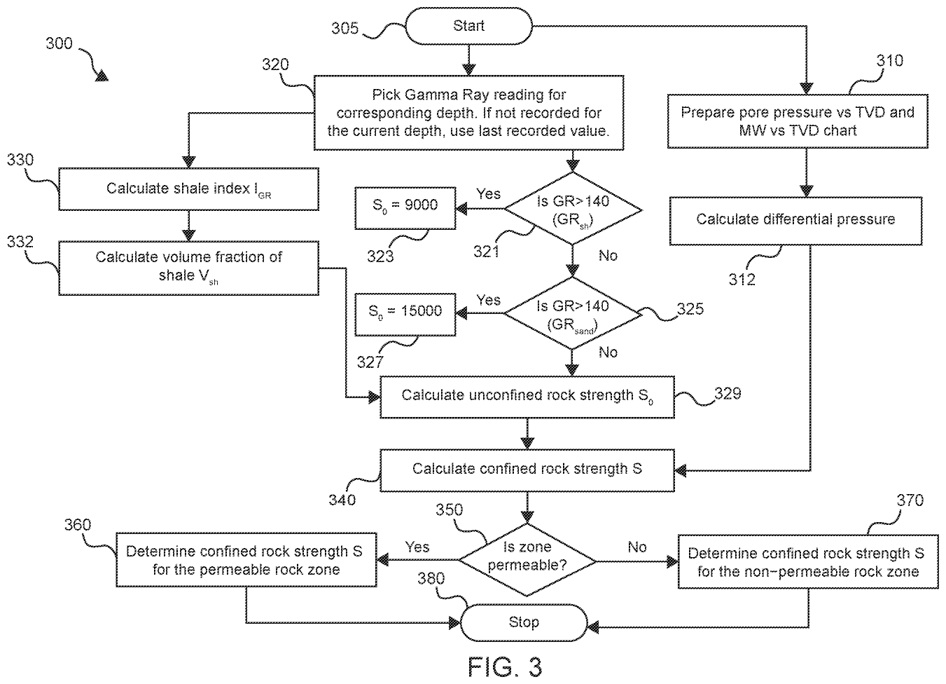

FIG. 3 illustrates a flow diagram of an example of a method for calculating formation properties using confined compressive strength according to the principles of the disclosure;

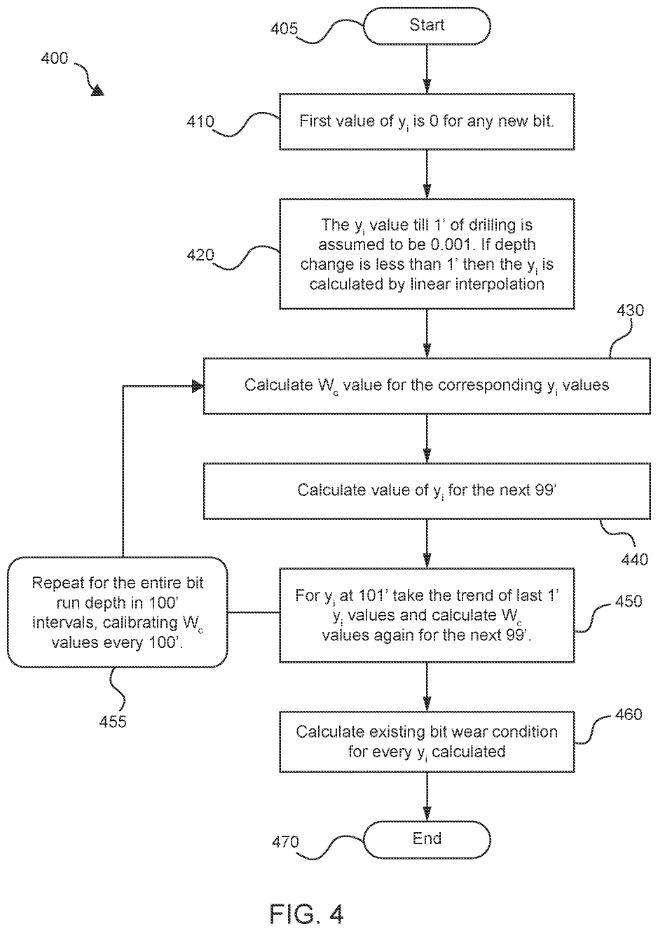

FIG. 4 illustrates a flow diagram of an example method for calculating an existing bit wear condition that can utilize an iterative process for quantifying the bit/rock interaction according to the principles of the disclosure;

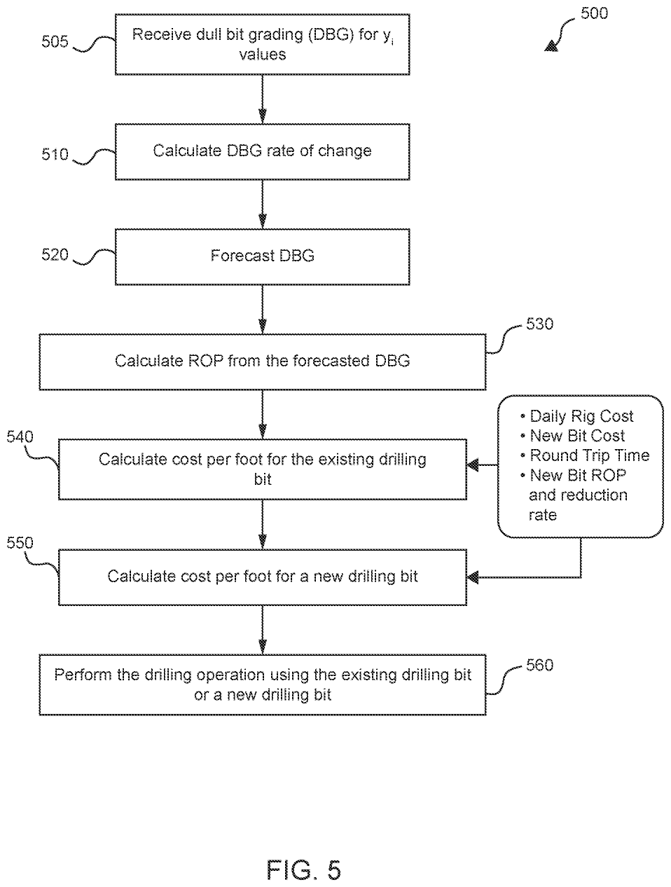

FIG. 5 illustrates an example of a flow diagram of a method that models a costing parameters using a revised rate of penetration (ROP) according to the principles of the disclosure;

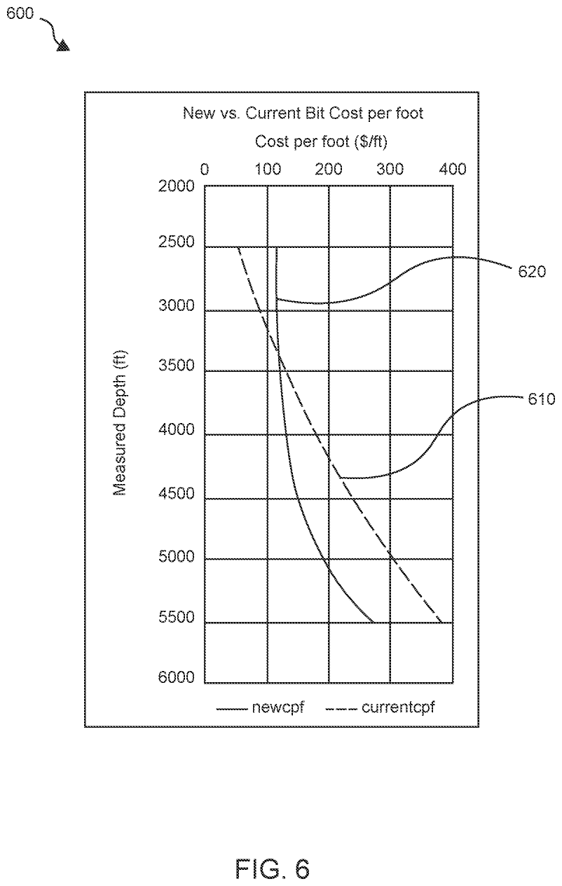

FIG. 6 illustrates a graph comparing the cost per foot for using an existing drilling bit versus the cost per foot for using a new drilling bit; and

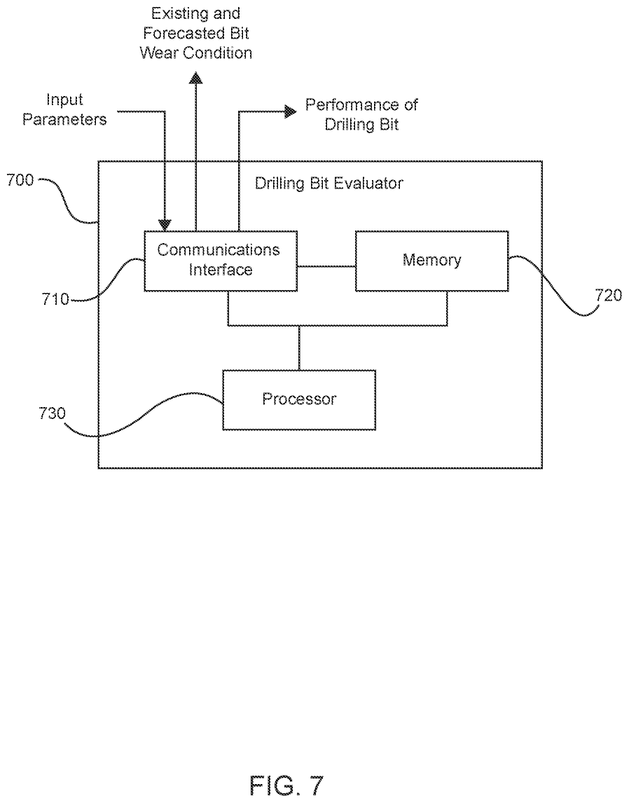

FIG. 7 illustrates a block diagram of an example of a drilling bit evaluator constructed according to the principles of the disclosure.

### DETAILED DESCRIPTION

The disclosure provides a method for evaluating worn out condition of a drilling bit in real time, i.e., when the drilling bit is drilling in the borehole. The method disclosed herein for evaluating the drilling bit worn out condition incorporates both physics based as well as machine learning based aspects to provide existing and forecasted evaluations. The properties evaluated include, for example, bit wear condition of the drilling bit, operating parameters of the drilling operation, and economic performance of the drilling operation. The disclosed method helps users, such as an operator, to know the condition of a drilling bit without pulling the drilling bit out of a borehole, which saves valuable rig time. In addition to a method an apparatus for evaluating drilling bit properties is also disclosed.

The machine learning aspects of the disclosure can be utilized for forecasting various properties, such as bit wear condition and a wear pattern of a drilling bit. The machine learning method also helps in recognizing the trend of the bit wear, mechanical specific energy, rate of penetration, and other parameters to help corroborate the physics-based calculations performed. The machine learning can be utilized to provide forecasts and evaluations in real time. Since the forecasts and evaluations can happen in real time, the user has an informed decision before pulling a drilling bit out of a borehole. The machine learning process can utilize one or more various conventional neural networks or deep learning neural networks, such as feedforward, convolutional, or transformer-based networks. The machine learning process can utilize one or more various conventional transfer functions and training algorithms.

In some aspects, the training of the machine learning can be automated, allowing the machine learning to operate with no or minimal user intervention at a well site. In this aspect, costs can be lowered by reducing the number of well site operators or engineers present at the well site.

Turning now to the figures, FIG. 1 is an illustration of a diagram of an example drilling system 100 that can evaluate properties of a drilling bit in a borehole according to the principles of the disclosure. The drilling system 100 can be, for example, a logging while drilling (LWD) system, a measuring while drilling (MWD) system, a seismic while drilling (SWD) system, a telemetry while drilling (TWD) system, an injection well system, an extraction well system, and other borehole systems. Drilling system 100 includes a derrick 105, a well site controller 107, and a computing system 108. Well site controller 107 includes a processor and a memory and is configured to direct operation of drilling system 100. Derrick 105 is located at a surface 106.

Extending below derrick 105 is an active borehole 110 with downhole tools 120 at the end of a drill string 115. Downhole tools 120 can include various downhole tools, such as a formation tester or a bottom hole assembly (BHA). At the bottom of downhole tools 120 is a drilling bit 122. Other components of downhole tools 120 can be present, such as a local power supply (e.g., generators, batteries, or capacitors), telemetry systems, sensors, transceivers, and control systems. Active borehole 110 is surrounded by subterranean formations 150, including subterranean formations 152 and 154.

Well site controller 107 or computing system 108, which can be communicatively coupled to well site controller 107, can be utilized to communicate with downhole tools 120, such as sending and receiving telemetry, data, instructions, subterranean formation measurements, and other information. Well site controller 107 can also be used to obtain surface readings such as weight on bit, hook load, pressure, torque, flow rate, rate of penetration etc. Computing system 108 can be proximate well site controller 107 or be a distance away, such as in a cloud environment, a data center, a lab, or a corporate office. Computing system 108 can be a laptop, smartphone, PDA, server, desktop computer, cloud computing system, other computing systems, or a combination thereof, that are operable to perform the processes described herein. Well site operators, engineers, and other personnel can send and receive data, instructions, measurements, and other information by various means, now known or later developed, with computing system 108 or well site controller 107. Well site controller 107 or computing system 108 can communicate with downhole tools 120 using various means, now known or later developed, to direct operations of downhole tools 120.

The methods and processes disclosed herein can be implemented in the downhole tools 120, the well site controller 107, the computing system 108, or a combination thereof. In some aspects, downhole tools 120 can include one or more sensors to collect parameters of the subterranean formation and parameters of the borehole environment, such as gamma ray measurements, fluid pressure, fluid temperature, and other parameters. Sensors can also be used to record surface values such as weight on bit, hook load, torque, pressure, flow rate, rate of penetration etc. In some aspects, part of the process can be implemented in downhole tools 120 and part can be implemented in well site controller 107 or computing system, where downhole tools 120 is communicatively coupled to well site controller 107. The well site controller 107 and/or the computing system 108 can include the algorithms or part of the algorithms represented by the methods 200, 300, 400, and 500 as disclosed herein. A computing device, such as computing system 108, can use one or more algorithms, such as machine learning, decision tree, random forest, logistic regression, linear, stochastic, and other statistical algorithms to perform one or more of the steps of method 200, 300, 400, or 500.

FIG. 1 depicts an onshore operations and a specific borehole configuration. Those skilled in the art will understand that the disclosure is equally well suited for use in offshore operations and is equally well suited for use in boreholes having other orientations including vertical boreholes, horizontal boreholes, slanted boreholes, multilateral boreholes, and other borehole types.

FIG. 2 illustrates a flow diagram of an example of a method 200 of evaluating properties of a drilling bit according to the principles of the disclosure. Method 200 can utilize one or more of the methods 300, 400, and 500, or other methods or models. The cost parameters mentioned in the various methods 200, 300, 400, and 500 are subject to various options such as daily rate, cost per hour, cost per foot, or any other parameter that defines the price and cost associated with operation of a drilling rig.

Methods 200, 300, 400, and 500, or at least a portion thereof, can represent an algorithm and be encapsulated in software code or in hardware, for example, an application, a code library, a dynamic link library, a module, a function, a RAM, a ROM, and other software and hardware implementations. The software can be stored in a file, database, or other computing system storage mechanism. At least a portion of the methods 200, 300, 400, and 500, can be partially implemented in software and partially in hardware.

Methods 200, 300, 400, and 500, or at least a portion thereof, can be performed on a computing system, such as a well site controller, a server, a laptop, a mobile device, a cloud computing system, or other computing system capable of receiving the input parameters and outputting results. Other computing systems can be a smartphone, a mobile phone, a PDA, a laptop computer, a desktop computer, a server, a data center, a cloud environment, or other computing system. The well site controller 107 and/or the computing system 108 of FIG. 1 provide examples of computing systems in which at least a portion of the methods 200, 300, 400, and 500 can be performed. The computing system can be located proximate a borehole or can be located in a data center, a cloud environment, a lab, a corporate office, or other distance locations. The method 200 begins in step 205.

In step 210, subterranean formation measurements are obtained. The subterranean formation measurements can be obtained in real time. The formation measurements can be obtained via downhole sensors or even offset well data. For example, gamma ray measurements can be obtained downhole for determining subterranean formation types. Other types of sensors can also be used, such as acoustic or resistive sensors. The downhole sensors can be used to obtain the measurements with respect to the location of the drilling bit in the borehole, such as formation 154 proximate the drilling bit 122 in FIG. 1. Sensors can also be used to obtain data from surface equipment, such as weight on bit, rate of penetration, revolutions per minute, torque etc., which can help in determining the operational parameters.

Formation properties are determined in step 220. The formation properties can be determined using the obtained measurements and can correspond to a subterranean formation at a location of the drilling bit in the borehole, such as formations 152 and 154 in FIG. 1. As such, the formation properties are determined for the properties in which the drilling bit comes into contact.

Various methods can be used to calculate the formation properties. In an example method, confined compressive strength of the rock is used and calculated using gamma ray values, pore pressure values and mud weight. Gamma ray values can be measured in real time (using LWD/MWD-Gamma Ray tool) and/or taken from offset wells. Pore pressure values can also be taken from offset wells. Method 300 represented by the flow chart in FIG. 3 provides an example method for calculating formation properties using confined compressive strength.

As noted above the formation properties can be considered as confined compressive strength but can be considered in other forms as well such as brittleness, unconfined compressive strength, hardness, etc. Accordingly, the formation property can be calculated with different methods and parameters such as, but not limited to, using other petrophysical/geological/seismic parameters, including sonic log, porosity log, density log etc. Machine learning or Artificial Intelligence can also be used to calculate these values based on the historical data available.

In step 230, an existing bit wear condition of the drilling bit is calculated based on the formation properties. A bit wear condition of the drilling bit can be a bit worn out value that corresponds to a dull bit grading value. One challenge for calculating a bit wear condition is quantifying the interaction between a drilling bit and the rock or subterranean formation. Method 400 represented by the flow diagram of FIG. 4 provides an example method for calculating the existing bit wear condition that can utilize an iterative process for quantifying the bit/rock interaction. In the method 400, a bit wear constant (Wc) value is calculated. This Wc value can either be assumed by a user and directly used in the calculation or calibrated and calculated using an iterative process as shown in FIG. 4. For example, the first few feet of real time data can be used for calculating Wc values by assuming a small amount of wear in the bit. This calculated Wc value is then utilized for the next several feet. Since the Wc value may change as the cutting progresses altering the cutter structure, a fresh Wc value is calculated based on the trend observed. Method 400 calibrates the bit-rock interaction constant, Wc in this example, every 100 feet for better results. This technique can also be replaced with one constant for the bit and other parameters, wherein an output incorporates a methodology to identify an optimum way of calibrating the bit-rock interaction parameters. The bit and rock interaction can be represented in several ways besides W_{c}. For example, the bit and rock interaction can be modeled or designed using other industry methods and parameters. The values of constants for the modeling can depend on the type of rock and bit.

Other calculations and/or methods can also be used to calculate the existing bit wear condition values, in one form or another. The resulting output can be the value of the dull bit grading as one number representing an average for the entire bit.

A forecasted bit wear condition of the drilling bit is provided in step 240 based on the existing bit wear condition. Performing forecasting calculations for the bit wear condition and predicting the wear pattern of the bit can be beneficial in managing the drilling operation. Such information enables the user to have a look ahead based on the observed trends and decide, for example, if the drilling bit should be replaced before continuing to drill. The forecasting can be done using various methods, such as Autoregressive Integrated Moving Average (ARIMA) modeling. Other time series forecasting models can also be used, each having specific advantages and disadvantages. For example, ARIMA modelling can computationally provide forecasting deeper into the future faster compared to other forecasting models. Other deep learning-based forecasting models like Long and Short Term Memory (LSTM), Convolutional Neural Network (CNN) and Transformer based models can be used.

In step 250, performance of the drilling bit is evaluated based on the forecasted bit wear condition. One measure of performance is the cost effectiveness of the existing drilling bit. Various methods for calculating cost effectiveness can be used. For example, various complex methods can be used to model the cost per foot calculations or any other such costing parameters. Method 500 represented in FIG. 5 provides an example of one method that uses a revised rate of penetration (ROP).

Based on the forecasted values of the bit wear condition, the ROP can be revised. A revised ROP can be calculated assuming similar weight on bit (WOB), rotations per minute (RPM) and formation properties as observed in real time. The cost effectiveness of the bit performance can be evaluated utilizing the revised ROP. Method 500 can be used to calculate and compare the cost per foot for a drilling rig when continuing to drill with existing drilling bit, and the cost per foot to drill with a new drilling bit, which includes the cost to pull the existing drilling bit out of the borehole and go back in the borehole with the new drilling bit. The ROP for the new drilling bit can be assumed in method 500 but can also be calculated and predicted in different ways, such as using historical trend. The ROP allows a user to have a cost-effective vision of the drilling operation and decide to pull the existing drilling bit out of hole if the bit has worn out too much.

In step 260, the drilling operation is managed based on the forecasted bit wear and/or the determined performance of the drilling bit. Based on one or more of the determined information, the drilling operation may continue with the existing drilling bit, or another drilling bit can be used. Additionally, the operating parameters of the existing drilling bit can be changed based on the determined information. An operator can use the forecasted bit wear and/or the determined performance of the drilling bit to manage the drilling operation. The information can be provided to the operator via various means, including visual or audible user interfaces. A computing device that performs at least some of the steps of method 200 can provide the information on a screen or in a report that can be printed. In some examples, operating parameters can be automatically changed based on the forecasted bit wear and/or the determined performance of the drilling bit.

The method 200 continues to step 270 and ends.

FIG. 3 illustrates a flow diagram of an example of a method 300 for calculating formation properties using confined compressive strength according to the principles of the disclosure. The method 300 provides an example for calculating the formation property that a drilling bit contacts, such as subterranean formations 152 and 154 of FIG. 1. In the method 300, confined compressive strength of a formation is calculated using gamma ray values, pore pressure values and mud weight. Gamma ray values can be measured in real time using a gamma ray sensor, such as an LWD/MWD gamma ray tool of downhole tools 120, and/or taken from offset wells. Pore pressure values can also be taken from offset wells. The method 300 starts in step 305 and proceeds to step 310 and 320.

In step 310, a pore pressure versus true vertical depth (TVD) and the drilling fluid density (MW) in pounds per gallon (ppg) versus the TVD chart is prepared. The charts can be prepared from various logs and sensors readings collected at a borehole by a drilling system, such as drilling system 100. From step 310, the differential pressure is determined in step 312. The differential pressure Pₑ can be determined using Equation 1, wherein P_{P} is pore pressure in equivalent mud weight units.

Pₑ=0.052×TVD×(MW−P_{P}) Equation 1

In Equation 1, the Pₑ is in pounds per square inch (psi), the TVD is in feet, and P_{P} is in the unit of ppg as is MW. As noted above the pore pressure values P_{P} can be taken from offset wells.

In step 320, a gamma ray reading (GR) is selected for a corresponding depth of the drilling bit. The gamma ray reading can be selected from a measurement log. If the log does not include a reading for the current depth of the drilling bit, the last recorded value in the log closest to the current drilling bit depth can be used. The unit of radioactivity used for natural gamma ray logs is based on an artificially radioactive concrete block at the University of Houston, Tex., USA, that is defined to have a radioactivity of 200 American Petroleum Institute (API) units.

From step 320, the method 300 continues to step 330, wherein the shale index I_{GR} is determined. I_{GR} is a dimensionless value that can be calculated using Equation 2, wherein GRₛₕ=140 and GR_{sand}=40.

$${I}_{GR} = \frac{G R - G {R}_{sand}}{G {R}_{shale} - G {R}_{sand}} \qquad Equation 2$$

In step 332, the volume fraction of shale Vₛₕ is determined. Vₛₕ is also a dimensionless value and can be calculated using Equation 3.

Vₛₕ=0.33(2^{2I}^{_{GR}}−1) Equation 3

Returning now to step 320, the method 300 also continues to step 321, wherein a determination is made if the gamma ray reading is greater than 140, which is a recognized gamma ray reading for shale. If so, the unconfined rock strength S₀ is set to 9000 in step 323. If the gamma reading is not greater than 140, then the method 300 continues to step 325 where a determination is made if the gamma reading is less than 40, which is a recognized gamma ray reading for sand. If so, the unconfined rock strength S₀ is set to 15000 in step 327. If not, the method continues to step 329 and the unconfined rock strength S₀ is determined using Equation 4. The where unconfined rock strength Vₛₕ determined in step 332 can be used.

S₀=S_{0,sh}+(S_{0,sand}−S_{0,sh})·exp(−5Vₛₕ) Equation 4

Method 300 continues to step 340 wherein the confined rock strength S is determined. Equation 5 can be used to calculate the confined rock strength S. The differential pressure Pₑ from step 312 can be used in step 340.

S=S₀ (1+αₛPₑ^{b}*) Equation 5

In Equation 5, aₛ and bₛ are dimensionless, rock strength lithology coefficients that are known in the industry. Pₑ refers to the differential pressure or the bottom hole pressure depending on the rock permeability.

The method continues to step 350 where a determination is made if the rock zone is permeable. The determination of permeable or not permeable can be based on the differential pressure, such as determined in step 312. A comparison of the differential pressure to known values for permeable rock can be used.

If permeable, the method continues to step 360, and the confined rock strength S is determined for the permeable rock zone. Equation 6 can be used to calculate this confined rock strength S.

S=S₀ (1+0.0133×Pₑ\hat{ }0.577) Equation 6

If not permeable, the method continues to step 370, and the confined rock strength S is determined for the non-permeable rock zone. Equation 7 can be used to calculate the confined rock strength S for the non-permeable rock zone.

S=S₀ [1+0.00432×{Pₑ+(0.052×TVD_{fc}×PorePress._{ppg})}^{0.782}] Equation 7

From step 360 and 370, the method 300 continues to step 380 and ends.

FIG. 4 illustrates a flow diagram of an example method 400 for calculating an existing bit wear condition that can utilize an iterative process for quantifying the bit/rock interaction according to the principles of the disclosure. The method 400 uses real time data for the first few feet for calculating Wc values by assuming a small amount of wear in the bit. This calculated Wc value is then utilized for the next several feet and a fresh Wc value is calculated based on an observed trend observed since the Wc value may change as the cutting progresses altering the cutter structure. Method 400 calibrates the bit-rock interaction constant Wc in this example at every hundred feet. Other greater or lesser intervals can also be used based on factors such as experience, processing time, desired results, or a combination thereof. The method 400 begins in step 405.

In step 410, a fractional bit wear factor yᵢ is set to zero for a new drilling bit. In step 420, the fractional bit wear factor yᵢ is determined for the drilling bit for the first foot. The fractional bit wear factor yᵢ can be determined by assuming a value of 0.001 for one foot of drilling. If the change in depth is less than one foot, then the fractional bit wear factor yᵢ can be calculated by linear interpolation.

A bit wear constant Wc is determined in step 430 for corresponding fractional bit wear factor yᵢ values. Equation 8 below can be used for calculating the bit wear constant Wc.

$${W}_{ci} = \frac{( {y}_{i}^{3} - {y}_{i - 1}^{3} ) \times R O {P}_{i , ft / hr} \times ( 1 - {y}_{i - 1} )}{\begin{matrix}π \times 1562.5 \times {D}_{b , in} \times {α}_{0 i} \times {S}_{i , psi} \times \\ ( {D}_{i , ft} - {D}_{i - 1 , ft} ) \times ( 1 - {y}_{i} ) \times {WOB}_{i , kips} \times {N}_{i , RPM}\end{matrix}}$$

In Equation 8, D_{b,in} is the diameter of the drilling bit in inches, S_{i,psi} is the confined compressive strength, D_{i,ft} is the average diameter of cutter track cylinders in feet, WOB_{i,kips} is the weight of bit in 1000 pounds-force, and N_{i,RPM} is the drilling bit revolutions per minute. If multiple bit wear constant Wc are calculated for a one-foot interval, then the average bit wear constant Wc for the one foot interval can be calculated and used.

In step 440, the fractional bit wear factor yᵢ is determined for the next ninety-nine feet. The fractional bit wear factor yᵢ for the next ninety-nine feet can be calculated using Equation 9 provided below.

$${y}_{i} = \sqrt[a]{\frac{\begin{matrix}π \times 1562.5 \times {W}_{ci} \times {D}_{b , in} \times {α}_{0 i} \times {S}_{i , psi} \times \\ ( {D}_{i , ft} - {D}_{i - 1 , ft} ) \times ( 1 - {y}_{i} ) \times {WOB}_{i , kips} \times {N}_{i , RPM}\end{matrix}}{R O {P}_{i , ft / hr} \times ( 1 - {y}_{i - 1} )} + {y}_{i - 1}^{3}}$$

With Equation 9, more accurate results can be calculated when the difference between the average diameter of cutter track cylinders Dᵢ and Dᵢ₋₁ is small. For yᵢ at one hundred and one feet, the trend of the last one-foot yᵢ values can be used and calculate W_{c} values again for the next ninety-nine feet.

In step 450, values for the bit wear constant Wc is determined for the one hundred feet.

The method 400 then continues to step 455 and steps 430 to steps 450 are repeated in one-hundred-foot intervals for the drilling bit run depth. For each one-hundred-foot interval, the bit wear constant We is calculated.

Returning to step 450, the method 400 continues to step 460 where the existing bit wear condition is determined for the drilling bit. The existing bit wear condition can be calculated for every yi value calculated. In one example, the existing bit wear condition can be determined by multiplying the yi value by eight (8×yi). In step 470, the method 400 ends.

The existing bit wear conditions can used for forecasting drilling bit wear and cost per foot calculations. For example, the existing bit wear conditions can used by method 500. As indicated above, the existing bit wear condition can be dull bit grading. For the example method 500, dull bit grading will be used for existing bit wear condition.

FIG. 5 illustrates an example of a flow diagram of a method 500 that models costing parameters using a revised rate of penetration (ROP) according to the principles of the disclosure. The method 500 begins in step 505 with receipt of dull bit grading for yi. The dull bit grading can be calculated according to method 400 and can be for every yi that is calculated.

In step 510, the dull bit grading rate of change is determined. The dull bit grading rate of change can be calculated per foot and can be calculated using Equation 10.

$$Change in DBG = \frac{{DBG}_{i} - {DBG}_{i - 1}}{{Depth}_{i} - {Depth}_{i - 1}} \qquad Equation 10$$

In step 520, the dull bit grading is forecasted. ARIMA modeling can be used for the forecasting. Other time series forecasting models can also be used, including LSTM, CNN, and Transformer based models. The distance for forecasting can be fifty feet to two hundred feet. Other distances can also be selected based on such factors as accuracy, processing time, and forecasting model used.

With ARIMA modeling, an expanding window or a sliding window can be used for training. With the expanding window, the training window is expanding for each for forecast. For example, for the first forecast run, a training window of zero to one hundred feet of data is used to forecast 101 to 150 feet. For the second forecast run, the training window is expanded from zero to one hundred feet to zero to 150 feet for forecasting from 150 to 200 feet.

With the sliding window, the training window is shifted after a certain distance. For example, the training window is from 500 to 800 feet in the first forecast run for forecasting 801 to 1000 feet. In the second forecast run, the training window shift 200 feet to 700 to 1000 feet for forecasting from 1001 to 1200 feet. With the sliding window, the training data from the 500 to 700 feet is dropped for the second forecast run.

Both the expanding and the sliding window can be used together based on hole depth. For example, a drill bit wear time series data can be set-up taking borehole depth in feet as an index. The parameters related to cross validation (i.e., the train, test split) can also be set-up. In other words, the number of time series records used for training and the number of time series records used for testing can be established. The back testing type, either expanding or sliding, can be set-up as per the borehole depth, which can be determined by a real-time feed. In one example, if the borehole depth is less than 500 feet, then an expanding window is used and the roll window equals zero. If the borehole depth is greater than 500 feet, then the sliding window is used and the roll window is greater than zero.

The type of predictive model for a particular problem can be chosen by understanding the features, the relationships among different features, the patterns, and trends. In addition to univariate ARIMA modelling, as noted above other methods can also be used including forecasting using multi variate Vector Autoregressive (VAR) model wherein each time series is modelled by its own lag as well as other series lags. A Kalman Filter can also be used, and different RNN and LSTM architectures can also be used for multi-step forecasting.

The ROP is calculated from the forecasted DBG in step 530. The ROP can be calculated using the average of the last 100 WOB, RPM, α, confined compressive strength S values, and the last bit wear constant We value. Equation 11 provided below can be used for determining the new ROP for the forecasted DBG.

$$New R O {P}_{i , ft / hr} = \frac{\begin{matrix}π \times 1562.5 \times {W}_{ci} \times {D}_{b , in} \times {α}_{0 i} \times {S}_{i , psi} \times \\ ( {D}_{i , ft} - {D}_{i - 1 , ft} ) \times ( 1 - {y}_{i} ) \times {WOB}_{i , kips} \times {N}_{i , RPM}\end{matrix}}{( {y}_{i}^{3} - {y}_{i - 1}^{3} ) \times ( 1 - {y}_{i - 1} )}$$

For Equation 11, yᵢ=DBGᵢ/8. A limit can be used for calculating the new ROP based on a percentage of the forecasted distance. For example, with forecasting up to two hundred feet, the maximum ROP reduction can be set to ten percent of the current ROP for every two hundred feet.

Using the new ROP, the cost per foot for continuing drilling with the current bit is determined. Equation 12 can be used for calculating the cost per foot.

$$Cost per {foot}_{currentbit} = \frac{( \frac{Daily RigCost}{24} ) \times Depth of Cut}{Depth of Cut \times New R O P} \qquad Equation 12$$

As shown in FIG. 5, several inputs can be provided to calculate the cost per foot including the daily rig cost and depth of cut. The daily rig cost can be received as a value based on actual cost of the drilling rig. As shown in Equation 12, the daily rig cost is divided by twenty-four to provide an hourly cost. The depth of cut can be input as measured data determined from the drilling operation.

The cost per foot for a new drilling bit is determined in step 550. The cost per foot can be calculated using Equation 13 provided below.

$$Cost per {foot}_{New bit} = \frac{\begin{matrix}New Bit Cost + \{ ( \frac{Daily Rig Cost}{24} ) \times \\ ( Round Trip {Time}_{hrs} + \frac{Depth of cut}{New Bit R O P} ) \}\end{matrix}}{Depth of Cut}$$

The daily rig cost and depth of cut can also be received and used in Equation 13. The cost of a new bit, the round trip time in hours for replacing the existing drilling bit with a new bit, and the new bit ROP and reduction rate are examples of inputs received for Equation 13. The new bit ROP can be the maximum ROP observed in a last selected distance of the existing drilling bit. For example, the new bit ROP can be the maximum ROP observed in the last hundred feet of the existing drilling bit. The new bit ROP reduction rate can be set at a certain percentage of the new bit ROP and can be set at a determined drilling distance. The percentage and distance can be based on, for example, historical knowledge and information about the subterranean formation. The new bit ROP reduction rate can be, for example, set at ten percent of the new bit ROP for every two hundred feet.

The method continues to step 560 wherein a determination is made to perform the drilling operation using the existing drilling bit or a new drilling bit. The determination can be on the cost per foot for continuing with the existing drilling bit versus the cost for drilling using the new drilling bit. The determination can be based on the results of step 540 compared to the results of step 550. With step 540 and 550, a graph can be generated and used for comparison. FIG. 6 provides an example of such a graph. The determination can be made automatically via a computer or can be manually based on the results of steps 540 and 550. The method 500 can continue throughout the drilling operation.

FIG. 6 illustrates a graph 600 comparing the cost per foot for using an existing (or current) drilling bit versus the cost per foot for using a new drilling bit. the graph includes two plots: 610 for the cost per foot of using the existing drilling bit and 620 for the cost per foot for using a new drilling bit. The cost per foot for using an existing drilling bit can be determined via step 540 of method 500 and the cost per foot for using a new drilling bit can be determined via step 550 of method 500. The graph 600 can be generated automatically by a processor or manually. At a measured depth of about 3,400 feet, the two plots 610 and 620 intersect. At this point of intersection, graph 600 indicates a new drilling bit would be more cost effective than the existing drilling bit. As such, an operator can determine to replace the existing drilling bit with the new drilling bit and then continue drilling.

FIG. 7 illustrates a block diagram of an example of a drilling bit evaluator 700 constructed according to the principles of the disclosure. The drilling bit evaluator 700 includes at least one interface 710 for receiving and transmitting information, at least one memory 720 for storing data and computer programs, and at least one processor 730 for performing functions when directed by the computer programs. For example, the memory 720 can be a non-transitory memory that can store code corresponding to algorithms that direct the processor 730 to determine formation properties corresponding to a subterranean formation at a location of the drilling bit in the borehole, calculate an existing bit wear condition of the drilling bit based on the formation properties, forecast a bit wear condition of the drilling bit based on the existing bit wear condition, and evaluate performance of the drilling bit based on the forecasted bit wear condition. The stored code can correspond to algorithms represented by one or more of the methods 200, 300, 400, and 500. The stored code can be a computer program product. A combination of one or more of the methods 200, 300, 400, or 500 with other methods or portions of other methods can also be used to direct the processor 730 to perform similar functions.

The drilling bit evaluator 700 can be a computing device, such as the well site controller 107 and/or the computing system 108. The processor 730 can be configured with machine learning capabilities and/or Artificial Intelligence to perform some of the functions, such as forecasting and evaluating.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured means, for example, designed, constructed, or programmed, with the necessary logic and/or features for performing a task or tasks. A configured device, therefore, is capable of performing the task or tasks. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, because the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

As noted in the Summary, aspects disclosed herein include:
A. A method of evaluating properties of a drilling bit when in a borehole. In one example the method includes: (1) determining formation properties corresponding to a subterranean formation at a location of the drilling bit in the borehole, (2) calculating an existing bit wear condition of the drilling bit based on the formation properties, (3) providing a forecasted bit wear condition of the drilling bit based on the existing bit wear condition and real time parameters, and (4) evaluating performance of the drilling bit based on the forecasted bit wear condition.
B. An apparatus comprising at least one processor and memory, the memory including computer program code, the memory and the computer program code configured to, with the at least one processor, cause the apparatus to evaluate properties of a drilling bit in a borehole by performing at least the following: (1) determining formation properties corresponding to a subterranean formation at a location of the drilling bit in the borehole, (2) calculating an existing it wear condition of the drilling bit based on the formation properties, (3) forecasting a forecasted bit wear condition of the drilling bit based on the existing bit wear condition, and (4) evaluating performance of the drilling bit based on the forecasted bit wear condition.
C. A computer program product having a series of operating instructions stored on a non-transitory computer-readable medium that directs a data processing apparatus when executed thereby to perform operations. In one example the operations include: (1) determining formation properties corresponding to a subterranean formation at a location of the drilling bit in the borehole, (2) calculating an existing bit wear condition of the drilling bit based on the formation properties, (3) providing a forecasted bit wear condition of the drilling bit based on the existing bit wear condition and real time parameters, and (4) evaluating performance of the drilling bit based on the forecasted bit wear condition.

Each of aspects A, B, and C can have one or more of the following additional elements in combination.
Element 1: wherein the existing bit wear condition corresponds to a dull bit grading of the drilling bit. Element 2: wherein determining the formation properties includes utilizing a confined compressive strength method. Element 3: wherein utilizing the confined compressive strength method uses gamma ray measurements. Element 4: wherein calculating the existing bit wear condition includes quantifying interaction between the drilling bit and the subterranean formation. Element 5: wherein the quantifying includes iteratively determining a bit wear constant. Element 6: wherein the evaluating includes revising a rate of penetration of the drilling bit based on the forecasted bit wear condition. Element 7: wherein the evaluating further includes determining a cost effectiveness of the drilling bit based on the revised rate of penetration. Element 8: wherein providing the forecasted bit wear condition utilizes machine learning. Element 9: wherein evaluating the performance utilizes machine learning. Element 10: wherein evaluating the performance utilizes artificial intelligence. Element 11: wherein the present bit wear condition corresponds to a dull bit grading of the drilling bit. Element 12: wherein determining the formation properties includes utilizing a confined compressive strength method. Element 13: wherein utilizing the confined compressive strength method uses gamma ray measurements. Element 14: wherein calculating the existing bit wear condition includes quantifying interaction between the drilling bit and the subterranean formation. Element 15: wherein the quantifying includes iteratively determining a bit wear constant. Element 16: wherein the evaluating includes revising a rate of penetration of the drilling bit based on the forecasted bit wear condition. Element 17: wherein the evaluating further includes determining a cost effectiveness of the drilling bit based on the revised rate of penetration. Element 18: wherein the forecasting utilizes artificial intelligence. Element 19: wherein the evaluating utilizes machine learning.

What is claimed is:

1. A method of evaluating properties of a drilling bit when in a borehole, comprising:
determining formation properties corresponding to a subterranean formation at a location of the drilling bit in the borehole;
calculating an existing bit wear condition of the drilling bit based on the formation properties;
providing a forecasted bit wear condition of the drilling bit based on the existing bit wear condition and real time parameters; and
evaluating performance of the drilling bit based on the forecasted bit wear condition.

2. The method as recited in claim 1, wherein the existing bit wear condition corresponds to a dull bit grading of the drilling bit.

3. The method as recited in claim 1, wherein determining the formation properties includes utilizing a confined compressive strength method.

4. The method as recited in claim 3, wherein utilizing the confined compressive strength method uses gamma ray measurements.

5. The method as recited in claim 1, wherein calculating the existing bit wear condition includes quantifying interaction between the drilling bit and the subterranean formation.

6. The method as recited in claim 5, wherein the quantifying includes iteratively determining a bit wear constant.

7. The method as recited in claim 1, wherein the evaluating includes revising a rate of penetration of the drilling bit based on the forecasted bit wear condition.

8. The method as recited in claim 7, wherein the evaluating further includes determining a cost effectiveness of the drilling bit based on the revised rate of penetration.

9. The method as recited in claim 1, wherein providing the forecasted bit wear condition utilizes machine learning.

10. The method as recited in claim 1, wherein evaluating the performance utilizes machine learning.

11. The method as recited in claim 1, wherein evaluating the performance utilizes artificial intelligence.

12. An apparatus comprising at least one processor and memory, the memory including computer program code, the memory and the computer program code configured to, with the at least one processor, cause the apparatus to evaluate properties of a drilling bit in a borehole by performing at least the following:
determining formation properties corresponding to a subterranean formation at a location of the drilling bit in the borehole;
calculating an existing bit wear condition of the drilling bit based on the formation properties;
forecasting a forecasted bit wear condition of the drilling bit based on the existing bit wear condition; and
evaluating performance of the drilling bit based on the forecasted bit wear condition.

13. The apparatus as recited in claim 12, wherein the existing bit wear condition corresponds to a dull bit grading of the drilling bit.

14. The apparatus as recited in claim 12, wherein determining the formation properties includes utilizing a confined compressive strength method.

15. The apparatus as recited in claim 14, wherein utilizing the confined compressive strength method uses gamma ray measurements.

16. The apparatus as recited in claim 12, wherein calculating the existing bit wear condition includes quantifying interaction between the drilling bit and the subterranean formation.

17. The apparatus as recited in claim 16, wherein the quantifying includes iteratively determining a bit wear constant.

18. The apparatus as recited in claim 12, wherein the evaluating includes revising a rate of penetration of the drilling bit based on the forecasted bit wear condition.

19. The apparatus as recited in claim 18, wherein the evaluating further includes determining a cost effectiveness of the drilling bit based on the revised rate of penetration.

20. The apparatus as recited in claim 12, wherein the forecasting utilizes artificial intelligence.

21. The apparatus as recited in claim 12, wherein the evaluating utilizes machine learning.

22. A computer program product having a series of operating instructions stored on a non-transitory computer-readable medium that directs a data processing apparatus when executed thereby to perform operations for evaluating properties of a drilling bit when in a borehole, the operations comprising:
determining formation properties corresponding to a subterranean formation at a location of the drilling bit in the borehole;
calculating an existing bit wear condition of the drilling bit based on the formation properties;
providing a forecasted bit wear condition of the drilling bit based on the existing bit wear condition and real time parameters; and
evaluating performance of the drilling bit based on the forecasted bit wear condition.
